(19) United States
(12) Patent Application Publication
(10) Pub. No.: US 2017/0013844 A1
(43) Pub. Date: Jan. 19, 2017

(54) Process of Manufacturing Antimicrobial Fabrics

(71) Applicant: GRAND TEXTILE CO., LTD., NEW TAIPEI CITY (TW)

(72) Inventor: Jen-Huan Lu, New Taipei City (TW)

(21) Appl. No.: 14/801,909

(22) Filed: Jul. 17, 2015

(51) Int. Cl. A01N 65/08; A01N 65/22; A01N 25/34; A01N 65/32; A01N 65/20; A01N 65/30; A01N 25/12; A01N 65/40

(52) U.S. Cl. CPC A01N 65/08; A01N 25/12; A01N 65/22; A01N 65/40; A01N 65/32; A01N 65/20; A01N 65/30; A01N 25/34

(57) ABSTRACT

A process of manufacturing antimicrobial fabrics includes drying Rheum rhabarbarum, Sophora flavescens var. Flavescens, Forsythia suspensa, Coptis chinensis Franch, Rehmannia glutinosa, Anemarrhena asphodeloides, and Scutellaria lateriflora at 50° C. for about 6 to 12 hours, and grinding same to nanoscale powders; adding the nanoscale powders to a solution containing 95% by volume of ethanol, heating the solution at 50° C., and extracting the ethanol; adding water to the container after extracting for two hours, thereby obtaining a solution containing antimicrobial herbal medicinal components; adding about 1 to 3 wt % of Sodium dodecyl sulfate to the solution containing antimicrobial herbal medicinal components for emulsification; adding about 5 wt % of acrylic resin to the emulsified solution to form Liposomes containing the nano powder; adding the Liposomes to foam resin to form a mixture; and applying the mixture to fabrics to manufacture antimicrobial fabrics containing herbal medicinal components.

### BACKGROUND OF THE INVENTION

1. Field of the Invention

The invention relates to process of antimicrobial fabrics and more particularly to a process of manufacturing antimicrobial fabrics.

2. Description of Related Art

Physically, clothing serves many purposes: it can serve as protection from weather. It protects a wearer from rough surfaces, etc. by providing a barrier between the skin and the environment. Clothes can insulate against cold or hot conditions. Further, they can provide a hygienic barrier, keeping infectious and toxic materials away from the body. Clothing also provides protection from harmful radiation. Moreover, fabrics having antimicrobial and other features such as odor absorption are devised.

Conventionally, a process of manufacturing antimicrobial fabrics comprises adding zinc oxide, nano silver, etc. To threads. While fabrics articles treated by incorporating the metallic compounds into the yarns used to make the fabrics article are good, the metallic components may pose a health hazard.

Thus, the need for improvement still exists.

### SUMMARY OF THE INVENTION

It is therefore one object of the invention to provide a process of manufacturing antimicrobial fabrics containing herbal medicinal components, comprising drying Rheum rhabarbarum, Sophora flavescens var. Flavescens, Forsythia suspensa, Coptis chinensis Franch, Rehmannia glutinosa, Anemarrhena asphodeloides, and Scutellaria lateriflora in an oven at 50° C. for about 6 to 12 hours, and grinding same to nanoscale powders; adding the nanoscale powders to a solution containing 95% by volume of ethanol wherein weight ratio of the nanoscale powders to the solution is 1:20, heating a water tank with a container of the solution placed therein at 50° C., and extracting the ethanol; adding water to the container of the solution after extracting for two hours wherein weight ratio of the nanoscale powders to water is 1:20, thereby obtaining a solution containing antimicrobial herbal medicinal components; adding about 1 to 3% by weight of Sodium dodecyl sulfate to the solution containing antimicrobial herbal medicinal components for emulsification; adding about 5% by weight of acrylic resin to the emulsified solution to form Liposomes containing the nano powder; adding the Liposomes to foam resin to form a mixture; and applying the mixture to fabrics to manufacture antimicrobial fabrics containing herbal medicinal components.

The above and other objects, features and advantages of the invention will become apparent from the following detailed description taken with the accompanying drawings.

### BRIEF DESCRIPTION OF THE DRAWINGS

FIG. 1 is a flow chart illustrating a process of manufacturing antimicrobial nanoparticles containing herbal medicinal components according to the invention;

FIG. 2 is a flow chart illustrating a process of manufacturing antimicrobial fibers containing herbal medicinal components according to the invention;

FIG. 3 is a flow chart illustrating a process of manufacturing antimicrobial fabrics containing herbal medicinal components according to the invention;

FIG. 4 consists of seven photographs showing growths of species of Euglena in different environments;

FIG. 5 is a table showing a first test of antimicrobial capabilities of a fabric treated by the antimicrobial solution of invention with respect to a fabric; and

FIG. 6 is a table showing a second test of antimicrobial capabilities of a fabric treated by the antimicrobial solution of invention with respect to another fabric.

### DETAILED DESCRIPTION OF THE INVENTION

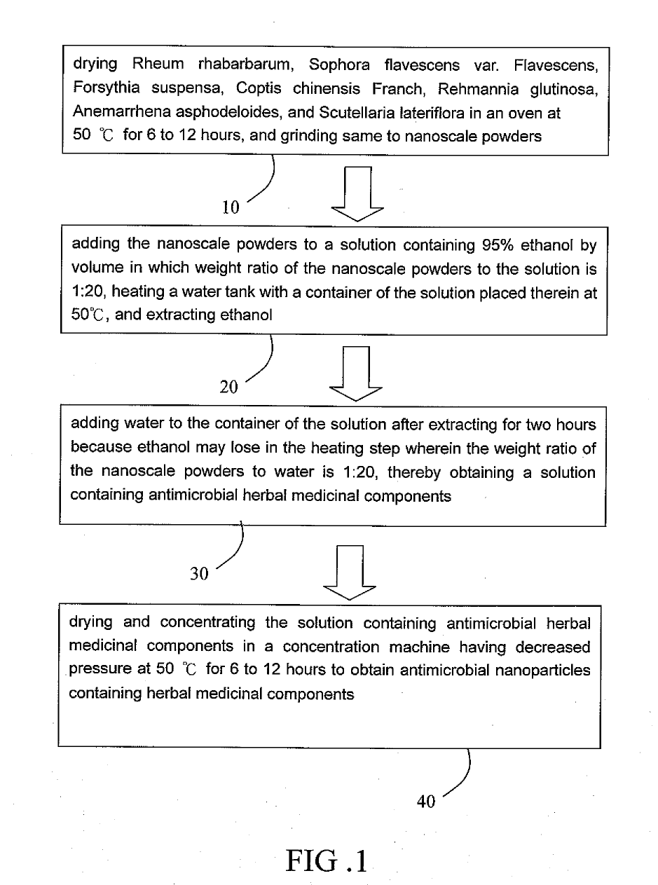

Referring to FIG. 1, a flow chart of a process of manufacturing antimicrobial nanoparticles containing herbal medicinal components according to the invention is illustrated.

The process comprises:

Step 10 of drying Rheum rhabarbarum, Sophora flavescens var. Flavescens, Forsythia suspensa, Coptis chinensis Franch, Rehmannia glutinosa, Anemarrhena asphodeloides, and Scutellaria lateriflora in an oven at 50° C. for 6 to 12 hours, and grinding same to nanoscale powders.

Step 20 of adding the nanoscale powders to a solution containing 95% ethanol by volume in which weight ratio of the nanoscale powders to the solution is 1:20, heating a water tank with a container of the solution placed therein at 50° C., and extracting ethanol.

Step 30 of adding water to the container of the solution after extracting for two hours. This is because ethanol may lose in the heating step. As such, the weight ratio of the nanoscale powders to water is maintained at 1:20. As a result, a solution containing antimicrobial herbal medicinal components is obtained.

Step 40 of drying and concentrating the solution containing antimicrobial herbal medicinal components in a concentration machine having decreased pressure at 50° C. for 6 to 12 hours to obtain antimicrobial nanoparticles containing herbal medicinal components.

Preferably, Rheum rhabarbarum is 30% by weight, Sophora flavescens var. Flavescens is 10% by weight, Forsythia suspensa is 10% by weight, Coptis chinensis Franch is 15% by weight, Rehmannia glutinosa is 15% by weight, Anemarrhena asphodeloides is 5% by weight, and Scutellaria lateriflora is 15% by weight, based on the total weight of Rheum rhabarbarum, Sophora flavescens var. Flavescens, Forsythia suspensa, Coptis chinensis Franch, Rehmannia glutinosa, Anemarrhena asphodeloides, and Scutellaria lateriflora.

Preferably, the nanoscale powders have a size of about 50 to 500 nanometers.

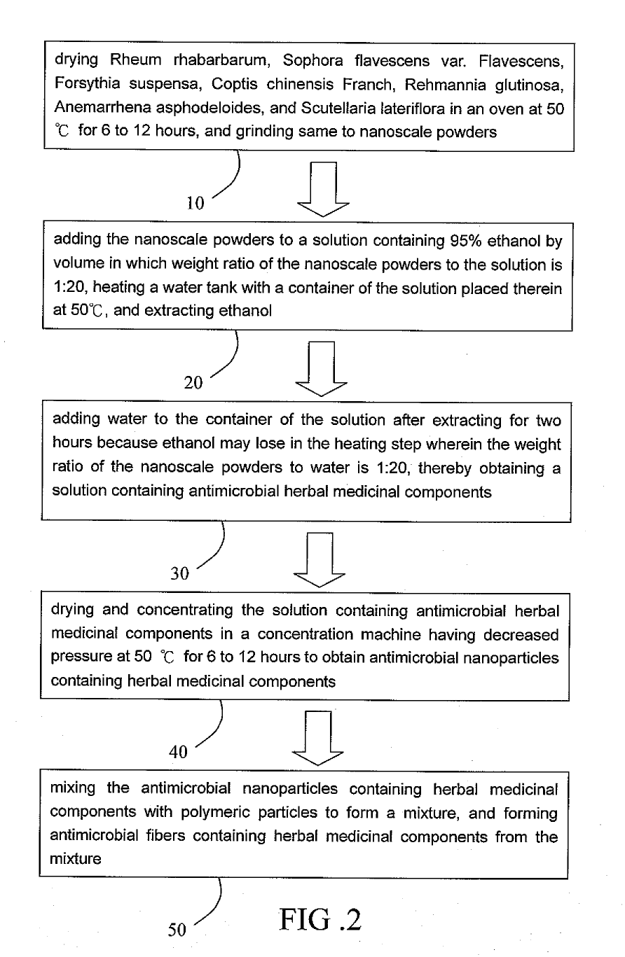

Referring to FIG. 2, a flow chart of a process of manufacturing antimicrobial fibers containing herbal medicinal components according to the invention is illustrated.

The process comprises:

Step 10 of drying Rheum rhabarbarum, Sophora flavescens var. Flavescens, Forsythia suspensa, Coptis chinensis Franch, Rehmannia glutinosa, Anemarrhena asphodeloides, and Scutellaria lateriflora in an oven at 50° C. for 6 to 12 hours, and grinding same to nanoscale powders.

Step 20 of adding the nanoscale powders to a solution containing 95% ethanol by volume in which weight ratio of the nanoscale powders to the solution is 1:20, heating a water tank with a container of the solution placed therein at 50° C., and extracting ethanol.

Step 30 of adding water to the container of the solution after extracting for two hours. This is because ethanol may lose in the heating step. As such, the weight ratio of the nanoscale powders to water is maintained at 1:20. As a result, a solution containing antimicrobial herbal medicinal components is obtained.

Step 40 of drying and concentrating the solution containing antimicrobial herbal medicinal components in a concentration machine having decreased pressure at 50° C. for 6 to 12 hours to obtain antimicrobial nanoparticles containing herbal medicinal components.

Step 50 of mixing the antimicrobial nanoparticles containing herbal medicinal components with polymeric particles to form a mixture, and forming antimicrobial fibers containing herbal medicinal components from the mixture.

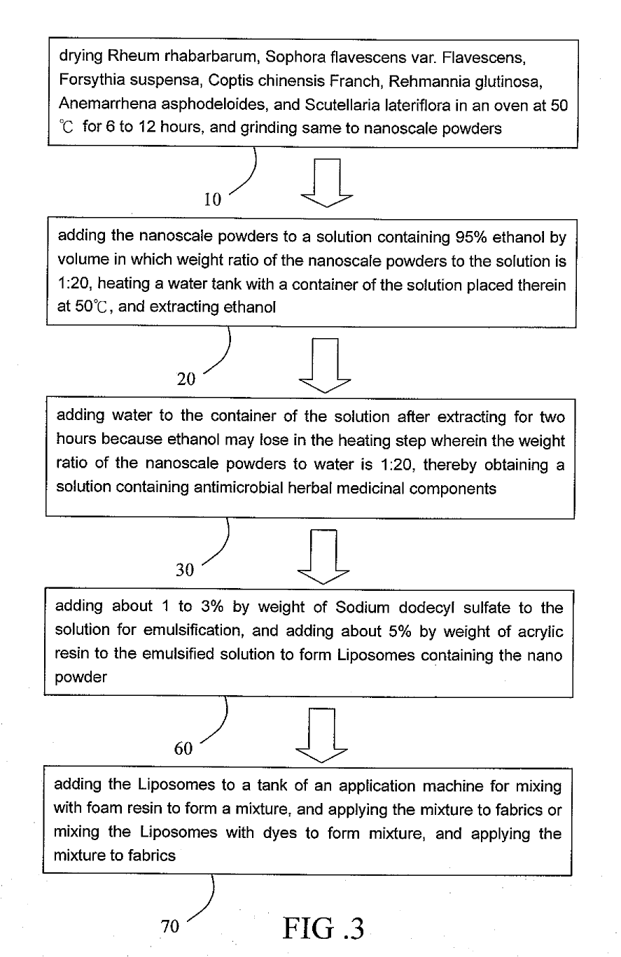

Referring to FIG. 3, a flow chart of a process of manufacturing antimicrobial fabrics containing herbal medicinal components according to the invention is illustrated.

The process comprises:

Step 10 of drying Rheum rhabarbarum, Sophora flavescens var. Flavescens, Forsythia suspensa, Coptis chinensis Franch, Rehmannia glutinosa, Anemarrhena asphodeloides, and Scutellaria lateriflora in an oven at 50° C. for 6 to 12 hours, and grinding same to nanoscale powders.

Step 20 of adding the nanoscale powders to a solution containing 95% ethanol by volume in which weight ratio of the nanoscale powders to the solution is 1:20, heating a water tank with a container of the solution placed therein at 50° C., and extracting ethanol.

Step 30 of adding water to the container of the solution after extracting for two hours. This is because ethanol may lose in the heating step. As such, the weight ratio of the nanoscale powders to water is maintained at 1:20. As a result, a solution containing antimicrobial herbal medicinal components is obtained.

Step 60 of adding about 1 to 3% by weight of Sodium dodecyl sulfate to the solution containing antimicrobial herbal medicinal components for emulsification, and adding about 5% by weight of acrylic resin to the emulsified solution to form Liposomes containing the nano powder.

Step 70 of adding the Liposomes to a tank of an application machine for mixing with foam resin to form a mixture, and applying the mixture to fabrics, thereby manufacturing antimicrobial fabrics containing herbal medicinal components. Alternatively, mixing the Liposomes with dyes to form mixture, and applying the mixture to fabrics, thereby manufacturing antimicrobial fabrics containing herbal medicinal components.

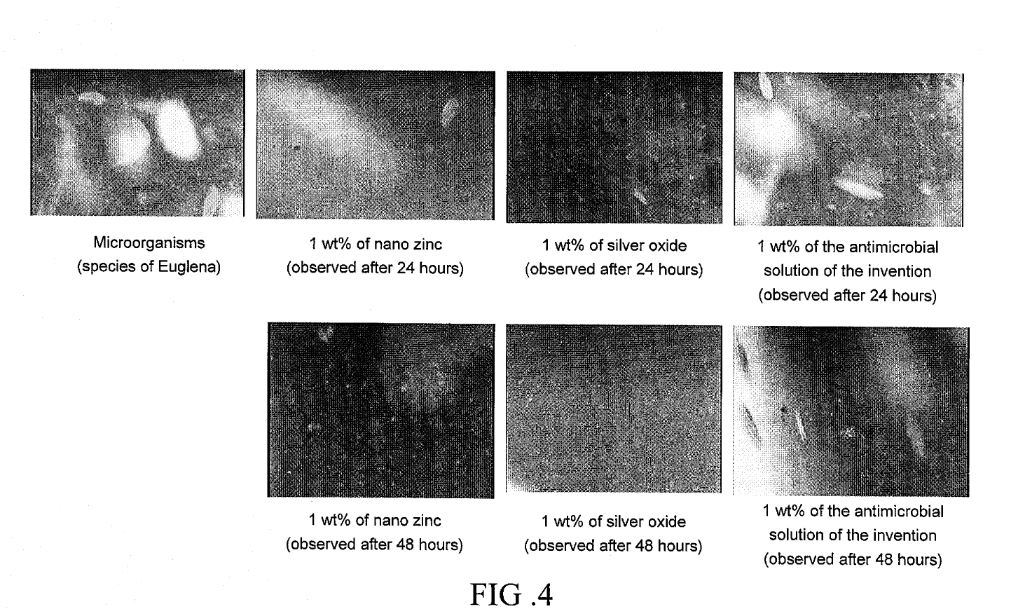

Referring to FIG. 4, it consists of seven photographs showing growths of species of Euglena in different environments. In detail, species of Euglenas are placed in antimicrobial solutions such as nano zinc solution, silver oxide solution, and the solution containing antimicrobial herbal medicinal components of the invention respectively. These solutions are first observed after 24 hours and further second observed after 48 hours. Following are facts observed by the present inventor: Species of Euglena live well in the solution containing antimicrobial herbal medicinal components of the invention in both the first and second observations. Further, more microorganisms exist in the solution containing antimicrobial herbal medicinal components of the invention. Species of Euglenas are died in the silver oxide solution in both the first and second observations. This means that silver oxide is fatal to Euglena. Some species of Euglenas are died in the nano zinc solution in the first observation, and all species of Euglenas are died in the nano zinc solution in the second observation. This means that nano zinc is more or less harmful to Euglena.

In light of above observations, it is concluded that while nano zinc and silver oxide are antimicrobial, they are metallic components harmful to the environment. To the contrary, the solution containing antimicrobial herbal medicinal components of the invention not only is capable of destroying or inhibiting the growth of microorganisms but also is friendly to the environment. Further, it does not irritate the skin or cause discomfort. Furthermore, the herbal medicinal components are natural, do not pollute the environment, and are environmental friendly.

### First Test of Antimicrobial Capabilities of the Invention

First, 100% by weight of poly micro interlocked knitted fabric is added to the antimicrobial solution of the invention. Next, a first test is conducted with respect to the antimicrobial capabilities of the treated fabric.

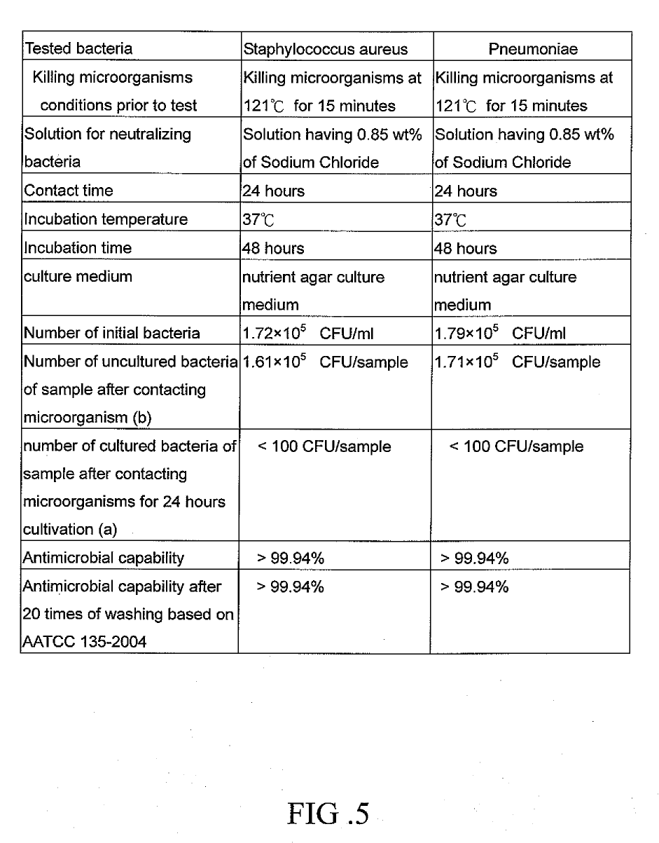

Referring to FIG. 5, it shows results of the first test. It is noted that expression of antimicrobial capabilities of specimens is (b−a)/b×100%. CFU is an abbreviation of colony-forming unit. < means Less. > means More. Test conditions are: machine washing 12 minutes, water temperature of 80° F., set rotational speed, and drying at a set low temperature.

It is found that the fabric treated by the invention is good at antimicrobial capabilities prior to washing. Further, the fabric treated by the invention has a 99% of antimicrobial capabilities after a number of times of washing.

### Second Test of Antimicrobial Capabilities of the Invention

Second, 100% by weight of polyester, 32% by weight of nylon, 25% by weight of cationic dyeable, and 8% by weight of spandex knitted fabric are added to the antimicrobial solution of the invention. Next, a second test is conducted with respect to the antimicrobial capabilities of the treated fabric.

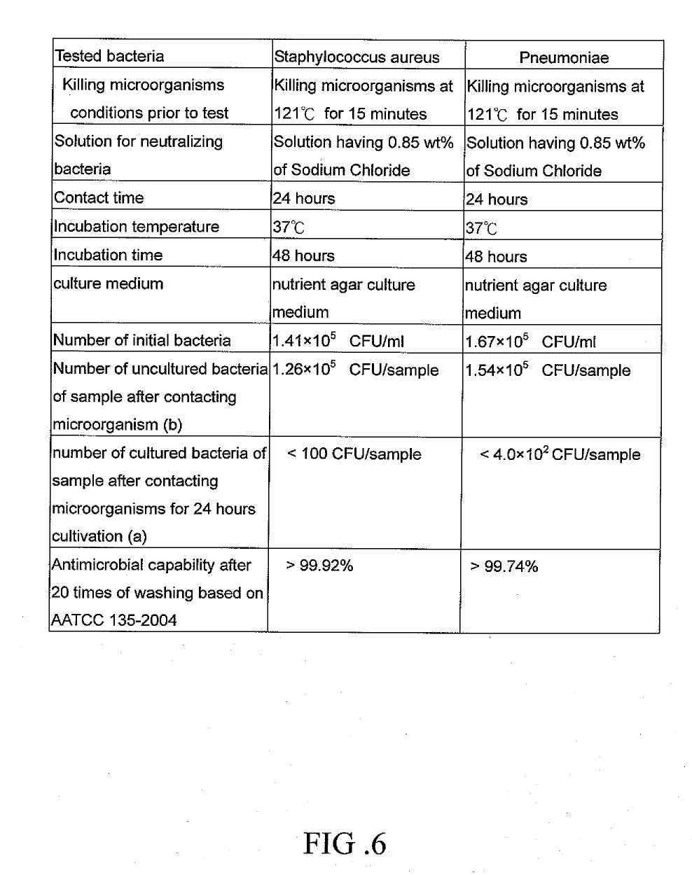

Referring to FIG. 6, it shows results of the second test. It is noted that expression of antimicrobial capabilities of specimens is (b−a)/b×100%. CFU is an abbreviation of colony-forming unit. < means Less. > means More. Test conditions are: machine washing 12 minutes, water temperature of 80° F., set rotational speed, and drying at a set low temperature.

It is found that the fabric treated by the invention has a more than 99% of antimicrobial capabilities after a number of times of washing.

While the invention has been described in terms of preferred embodiments, those skilled in the art will recognize that the invention can be practiced with modifications within the spirit and scope of the appended claims.

What is claimed is:

1. A process of manufacturing antimicrobial nanoparticles containing herbal medicinal components, comprising the steps of:
(a) drying Rheum rhabarbarum, Sophora flavescens var. Flavescens, Forsythia suspensa, Coptis chinensis Franch, Rehmannia glutinosa, Anemarrhena asphodeloides, and Scutellaria lateriflora in an oven at 50° C. for about 6 to 12 hours, and grinding same to nanoscale powders;
(b) adding the nanoscale powders to a solution containing 95% by volume of ethanol wherein weight ratio of the nanoscale powders to the solution is 1:20, heating a water tank with a container of the solution placed therein at 50° C., and extracting the ethanol;
(c) adding water to the container of the solution after extracting for two hours wherein weight ratio of the nanoscale powders to water is 1:20, thereby obtaining a solution containing antimicrobial herbal medicinal components; and
(d) drying and concentrating the solution containing antimicrobial herbal medicinal components in a concentration machine having decreased pressure at 50° C. for about 6 to 12 hours to obtain antimicrobial nanoparticles containing herbal medicinal components.

2. The process of claim 1, wherein Rheum rhabarbarum is 30% by weight, Sophora flavescens var; Flavescens is 10% by weight, Forsythia suspensa is 10% by weight, Coptis chinensis Franch is 15% by weight, Rehmannia glutinosa is 15% by weight, Anemarrhena asphodeloides is 5% by weight, and Scutellaria lateriflora is 15% by weight, based on the total weight of Rheum rhabarbarum, Sophora flavescens var; Flavescens, Forsythia suspensa, Coptis chinensis Franch, Rehmannia glutinosa, Anemarrhena asphodeloides, and Scutellaria lateriflora.

3. The process of claim 1, wherein the nanoscale powders have a size of about 50 to 500 nanometers.

4. A process of manufacturing antimicrobial fibers containing herbal medicinal components, comprising the steps of:
(a) drying Rheum rhabarbarum, Sophora flavescens var. Flavescens, Forsythia suspensa, Coptis chinensis Franch, Rehmannia glutinosa, Anemarrhena asphodeloides, and Scutellaria lateriflora in an oven at 50° C. for about 6 to 12 hours, and grinding same to nanoscale powders;
(b) adding the nanoscale powders to a solution containing 95% by volume of ethanol wherein weight ratio of the nanoscale powders to the solution is 1:20, heating a water tank with a container of the solution placed therein at 50° C., and extracting the ethanol;
(c) adding water to the container of the solution after extracting for two hours wherein weight ratio of the nanoscale powders to water is 1:20, thereby obtaining a solution containing antimicrobial herbal medicinal components;
(d) drying and concentrating the solution containing antimicrobial herbal medicinal components in a concentration machine having decreased pressure at 50° C. for about 6 to 12 hours to obtain antimicrobial nanoparticles containing herbal medicinal components;
(e) mixing the antimicrobial nanoparticles containing herbal medicinal components with polymeric particles to form a mixture; and
(f) forming antimicrobial fibers containing herbal medicinal components from the mixture.

5. A process of manufacturing antimicrobial fabrics containing herbal medicinal components, comprising the steps of:
(a) drying Rheum rhabarbarum, Sophora flavescens var. Flavescens, Forsythia suspensa, Coptis chinensis Franch, Rehmannia glutinosa, Anemarrhena asphodeloides, and Scutellaria lateriflora in an oven at 50° C. for about 6 to 12 hours, and grinding same to nanoscale powders;
(b) adding the nanoscale powders to a solution containing 95% by volume of ethanol wherein weight ratio of the nanoscale powders to the solution is 1:20, heating a water tank with a container of the solution placed therein at 50° C., and extracting the ethanol;
(c) adding water to the container of the solution after extracting for two hours wherein weight ratio of the nanoscale powders to water is 1:20, thereby obtaining a solution containing antimicrobial herbal medicinal components;
(e) adding about 1 to 3% by weight of Sodium dodecyl sulfate to the solution containing antimicrobial herbal medicinal components for emulsification;
(f) adding about 5% by weight of acrylic resin to the emulsified solution to form Liposomes containing the nano powder;
(g) adding the Liposomes to foam resin to form a mixture; and
(h) applying the mixture to fabrics to manufacture antimicrobial fabrics containing herbal medicinal components.

6. The process of claim 5, wherein after step (f) comprises the steps of (g1) adding the Liposomes to a tank of an application machine for mixing with foam resin to form a mixture, and (g2) applying the mixture to fabrics, thereby manufacturing antimicrobial fabrics containing herbal medicinal components.

7. The process of claim 5, wherein after step (f) comprises the steps of (g3) mixing the Liposomes with dyes to form mixture, and (g4) applying the mixture to fabrics, thereby manufacturing antimicrobial fabrics containing herbal medicinal components.
